(19) United States
(12) Patent Application Publication
(10) Pub. No.: US 2008/0176158 A1
(43) Pub. Date: Jul. 24, 2008

(54) Method of preparing toner, toner prepared using the method, image forming method using the toner, and image forming apparatus containing the toner

(75) Inventors: Min-young Cheong, Seoul (KR); Sang-eun Shim, Seoul (KR); Kyeong Pang, Suwon-si (KR); Yo-da Shin, Metropolitan-city (KR); Kyung-yol Yon, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/980,626

(22) Filed: Oct. 31, 2007

(30) Foreign Application Priority Data
Jan. 12, 2007 (KR) 10-2007-0003971

(51) Int. Cl. G03G 9/087; G03G 15/08

(52) U.S. Cl. 430/109.4; 430/137.17; 430/105; 399/262

(57) ABSTRACT

A method of preparing a toner, a toner prepared using the method, an image forming method using the toner, and an image forming apparatus containing the toner are provided. The method of preparing toner includes providing a toner composition including a polyester-macromonomer having double bonds at the ends of a molecular chain of a polyester, at least one polymerizable monomer, and a pigment, providing a stabilizer dispersion by mixing a dispersion medium and a stabilizer, and then mixing the obtained stabilizer dispersion with the toner composition to form droplets, and heat-treating the droplets to polymerize the mixture. The method of preparing the toner according to the present invention provides a toner having excellent properties of both a polyester-based monomer and a vinyl-based monomer and excellent gloss, durability, low-temperature fusing property, and stability and may be used to easily control types and sizes of the toner.

### CROSS-REFERENCE TO RELATED PATENT APPLICATION

This application claims the benefit of Korean Patent Application No. 10-2007-0003971, filed on Jan. 12, 2007, in the Korean Intellectual Property Office, the disclosure of which is incorporated herein by reference in its entirety.

### BACKGROUND OF THE INVENTION

1. Field of the Invention

The present invention relates to a method of preparing a toner and a toner prepared using the method. More particularly, the invention is directed to a method of preparing a toner having excellent properties of both a polyester-based monomer and a vinyl-based monomer. The toner has excellent gloss, durability, low-temperature fusing property, and stability. The method can be used to easily control types and sizes of the toner.

The invention is further directed to an image forming method using the toner, and an image forming apparatus containing the toner.

2. Description of the Related Art

In electrophotographic methods or electrostatic recording methods, developing agents are used to visualize electrostatic charge patterns or electrostatic latent images. Developing agents can be classified into two-component developing agents which consist of a toner and particles of a carrier, and one-component developing agents which substantially consist of only a toner. One-component developing agents can be classified into magnetic one-component developing agents, which contain magnetic components, and non-magnetic one-component developing agents, which do not contain magnetic components. In many cases, flowing agents, such as colloidal silica, etc. are often independently added to non-magnetic one-component developing agents to increase toner flowability. In general, toners include colorant particles obtained by dispersing pigments, such as carbon black, and other additives in binder resins to form particles.

Toners may be prepared using a pulverization method or a polymerization method. In the pulverization method, toners are obtained by melt mixing synthetic resins and pigments and, if necessary, other additives, pulverizing and then dispensing to obtain particles with desired particle diameters. In the polymerization method, pigments, polymerization initiators, and if necessary, other additives such as crosslinking agents and charge control agents are dissolved or uniformly dispersed in polymerizable monomers to obtain a polymerizable monomer composition, which is dispersed in an aqueous dispersion medium containing a dispersion stabilizer with a stirrer, thereby forming fine droplet particles of the polymerizable monomer composition. Subsequently, the fine droplet particles are warmed and suspension polymerized to obtain colored polymer particles as a chemically produced toner (CPT) with desired particle diameters.

In image forming apparatuses, such as electrophotographic apparatuses, electrostatic recording apparatuses, or the like, a uniformly charged photoreceptor is exposed to light to form an electrostatic latent image and a toner is attached to the electrostatic latent image, thereby forming a toner image. The toner image is transferred to a transfer material, such as transfer paper, and then a non-fused toner image is fused on the transfer material using various methods, for example, using heat, pressure, solvent steam, or the like. In the fusing process, the transfer material to which the toner image is transferred is generally passed between a fusing roll and a pressure roll and the toner is heat pressed to be fixed to the transfer material.

There is a need for improving the accuracy and resolution of images formed using image forming apparatuses such as electrophotographic copying machines, etc. Toners generally used in image forming apparatuses are mainly prepared using the pulverization method. However, colorant particles prepared using the pulverization method are likely to have a wide particle diameter distribution. In order to obtain desirable developing properties, it is necessary to dispense the pulverized product to control a particle diameter distribution within a narrow range. However, it is difficult to precisely control particle sizes and a particle size distribution in conventional kneading/milling processes during the production of toner particles used in an electrophotographic process or an electrostatic recording process. The production yield often decreases when producing toners with small particles using a dispensing process. Further, change/control of design of charging and fusing properties of toners is limited. Thus, CPTs have been attracting attention recently, since it is easy to control particle diameters of CPT particles and it is not necessary to perform troublesome processes, such as a dispensing process, etc. in the manufacture of CPTs.

The use of polyester-based monomers contributes to high gloss and high particle uniformity of toners, and thus they are mainly used in pulverization toners. However, it is difficult to dissolve polyester-based monomers in a solvent and to polymerize them in a solution. Thus, conventional polymerizable monomers, for example, styrene monomers, are used in resins for toner particles, and the polyester-based monomers are rarely used in the polymerization method.

Thus, there is a need for a method of effectively utilizing polyester-based monomers to provide toners having excellent physical properties, in a polymerization process, to produce CPTs having better properties than CPTs produced using the pulverization method.

### SUMMARY OF THE INVENTION

The present invention provides a method of preparing a toner having excellent properties of both a polyester-based monomer and a vinyl-based monomer. The toner has excellent gloss, durability, low-temperature fusing property, and stability. The method can be used to easily control types and sizes of the toner.

The present invention also provides a toner prepared using the method.

The present invention also provides a toner of which types and sizes of the toner particles may be easily controlled by the production method and where the toner has excellent gloss, durability, low-temperature fusing property, and stability.

The present invention also provides an image forming method that can be used to perform low-temperature fusion of high quality images using a toner of which types and sizes of the toner particles may be easily controlled and where toner has excellent gloss, durability, low-temperature fusing property, and stability.

The present invention also provides an image forming apparatus for performing low-temperature fusion of high quality images containing a toner where types and sizes may be easily controlled and which has excellent gloss, durability, low-temperature fusing property, and stability,

According to an aspect of the present invention, a method of preparing a toner, comprises: providing a toner composition comprising a polyester-macromonomer having double bonds at ends of a molecular chain of a polyester, at least one polymerizable monomer, and a pigment; obtaining a stabilizer dispersion by mixing a dispersion medium and a stabilizer, and then mixing the obtained stabilizer dispersion with the toner composition to form droplets; and heat-treating the droplets to polymerize the toner composition.

According to another aspect of the present invention, a toner prepared by providing a toner composition comprising a polyester-macromonomer having double bonds introduced into ends of the molecular chain, at least one polymerizable monomer, and a pigment; providing a stabilizer dispersion by mixing a dispersion medium and a stabilizer, and then mixing the obtained stabilizer dispersion with the toner composition to form droplets; and heat-treating the droplets to polymerize the toner composition.

According to still another aspect of the present invention, an image forming method is provided comprising: attaching a toner to a surface of a photoreceptor having an electrostatic latent image formed thereon to form a visible image and transferring the visible image to a transfer material, the toner being prepared by providing a toner composition comprising a polyester-macromonomer having double bonds at ends of the molecular chain, at least one polymerizable monomer, and a pigment; providing a stabilizer dispersion by mixing a dispersion medium and a stabilizer, and then mixing the obtained stabilizer dispersion with the toner composition to form droplets; and heat-treating the droplets to polymerize the toner composition.

According to yet another aspect of the present invention, there is an image forming apparatus is provided, comprising: an organic photoreceptor; an image forming unit for forming an electrostatic latent image on a surface of the photoreceptor; a toner receiving unit for containing a toner; a toner supply unit for supplying the toner to the surface of the organic photoreceptor to develop an electrostatic latent image on the surface of the organic photoreceptor into a toner image; and a toner transfer unit for transferring the toner image from the surface of the organic photoreceptor to a transfer material, the toner being prepared by providing a toner composition comprising a polyester-macromonomer having double bonds at ends of the molecular chain, at least one polymerizable monomer, and a pigment; providing a stabilizer dispersion by mixing a dispersion medium and a stabilizer, and then mixing the obtained stabilizer dispersion with the toner composition to form droplets; and heat-treating the droplets to polymerize the toner composition.

These and other aspects of the invention will become apparent from the following detailed description of the invention which discloses various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating a non-contact developing type image forming apparatus containing a toner prepared by a method according to an embodiment of the present invention;

FIG. 2 is a scanning electron microscopy (SEM) photographic image illustrating a toner prepared in Example 1;

FIG. 3 is a graph illustrating particle diameter vs. differential volume the toner prepared in Example 1; and

FIG. 4 is a graph illustrating differential scanning calorimetry (DSC) data of the toner prepared in Example 1.

### DETAILED DESCRIPTION OF THE INVENTION

Hereinafter, the present invention will be described in detail by explaining embodiments of the invention with reference to the attached drawings.

According to an embodiment of the present invention, a method of preparing a toner, comprises: providing a toner composition comprising a polyester-macromonomer having double bonds at ends of a molecular chain of a polyester, at least one polymerizable monomer, and a pigment; providing a stabilizer dispersion by mixing a dispersion medium and a stabilizer, and then mixing the obtained stabilizer dispersion with the toner composition to form droplets; and heat-treating the droplets to polymerize the toner composition.

The method of preparing a toner according to the current embodiment of the present invention may be used to produce a chemically produced toner (CPT) in a simple polymerization process and may provide the advantages of using a polyester, such as, high gloss and high modulus and decreased fusing temperature by changing compositions of polymerizable monomers. By using the method of preparing a toner according to the current embodiment of the present invention, a CPT that can be applied in a low-temperature fusion high speed printer to produce high quality images and exhibiting excellent physical properties, such as stability, durability, and fusing property, can be obtained.

The method of preparing a toner according to the current embodiment of the present invention has not been tried hitherto. In the method, polyester is chemically modified by introducing double bonds into ends of the molecular chain of the polyester to obtain a polyester-macromonomer, having double bonds at the ends of the macromonomer. The resulting polyester-macromonomer and at least one polymerizable monomer are suspended in an organic solvent to form a suspension. Then, a suspension polymerization in an aqueous solution or a dispersion polymerization in an organic solvent is performed to obtain toner particles.

In the suspension polymerization process, water-insoluble monomers and oil-soluble initiators are reacted in the presence of a polymer-based stabilizer using water as a dispersion medium to prepare polymer latexes. In the dispersion polymerization process, water-insoluble monomers and oil-soluble initiators are reacted in the presence of a polymer-based stabilizer using a single solvent, such as ethanol or methanol, or a mixture of solvents such as toluene, benzene, and 2-methoxy ethanol, and others, or a co-solvent with a small amount of water as a dispersion medium, wherein the monomers, initiators, and stabilizer are soluble in the dispersion medium.

The term macromonomer as used herein refers to a polymer having end portions of its chain substituted with at least one reactive functional group. The macromonomer participates in a polymerization reaction as a monomer during preparation of a polymer, thereby generating a structure having a different type of polymer chain with different characteristics chemically bound thereto, referred to as a hybrid resin. Due to the presence of the different types of polymers, different physical properties of the polymers may be embodied in a complex manner. Further, the binding between the chemically different polymers may increase compatibility between them, thereby enhancing their chemical, mechanical and thermal properties.

In addition, an increase in the compatibility of a crystalline polyester due to the chemical reaction between the polyester-macromonomer and the polymerizable monomer facilitates addition of the crystalline polyester to the reaction, and thus may remarkably increase a low-temperature fusing property of the final toner.

The polyester-macromonomer functions not only as a comonomer but also as a colloidal stabilizer during the suspension polymerization or dispersion polymerization.

The polyester-based resin used in the current embodiment of the present invention refers to a polymer having ester bonds (—COO—) in its backbone chain, prepared by polymerizing, for example, a divalent alcohol, such as bisphenol A, and terephthalic acid, trimellitic anhydride, fumaric acid or succinic acid derivatives.

Even though the polyester is a polymer prepared by polymerizing monomers, in an embodiment of the present invention, the polyester is used as a type of monomer which reacts with the at least one other polymerizable monomer to prepare a CPT. In an embodiment of the present invention, the polyester may be any type of polyester useful for preparing a toner.

As described above, even though the use of polyester monomers contributes to high gloss and high particle uniformity of toners, and the like, polyester monomers have not been frequently used in preparing CPTs since it is difficult to dissolve polyester monomers in a solvent and to polymerize them in a solution.

Thus, in an embodiment of the present invention, in order to use the polyester in preparing a toner composition using a CPT preparation process, double bonds are introduced into the polyester monomer or polyester-macromonomer.

The polyester-macromonomer used in the method of preparing a toner according to the current embodiment of the present invention will be explained as follows.

The polyester used in preparing the polyester-macromonomer may contain a hydroxyl group at the end portion of its chain as a reactive group necessary to introduce a double bond thereinto. The polyester as a polymerization monomer of a resin composition for the CPT may have a weight average molecular weight of about 1,000-100,000 and a glass transition temperature (Tg) of about 40-80° C.

The polyester may be polyethylene terephthalate (PET). PET is a saturated polyester which is generally prepared by performing polycondensation (condensation polymerization) between terephthalic acid and ethylene glycol.

The compound containing a double bond may be any compound which can react with the reactive group on the polyester to introduce a double bond into the polyester. Since a polymerization reaction occurs during preparation of the resin composition, any compound having a reactive group with a double bond necessary for the polymerization can be introduced to the ends of the polyester.

The double bond may be a vinyl-based double bond. Since the polyester having double bonds introduced thereinto is polymerized with a styrene-based monomer to prepare a resin composition having the advantages of the polyester and the styrene, the double bond may be a vinyl-based double bond which is polymerizable with a vinyl group of the styrene-based monomer.

In an embodiment of the present invention, the polyester-macromonomer may be prepared by adding a compound containing a diisocyanate group and a monomer containing a double bond sequentially to the polyester.

In order to introduce a double bond into an end portion of a molecular chain of the polyester, a polyester is reacted with a compound containing a diisocyanate group to introduce an isocyanate group into the end portion of the polyester. The resultant polyester with the isocyanate group is then reacted with a monomer containing a double bond to replace the introduced isocyanate group with the double bond of the monomer. In this way, the double bond is introduced into the end portion of the polyester.

Scheme 1 illustrates an example of a method of introducing a double bond into a polyester. In this example, the polyester is PET.

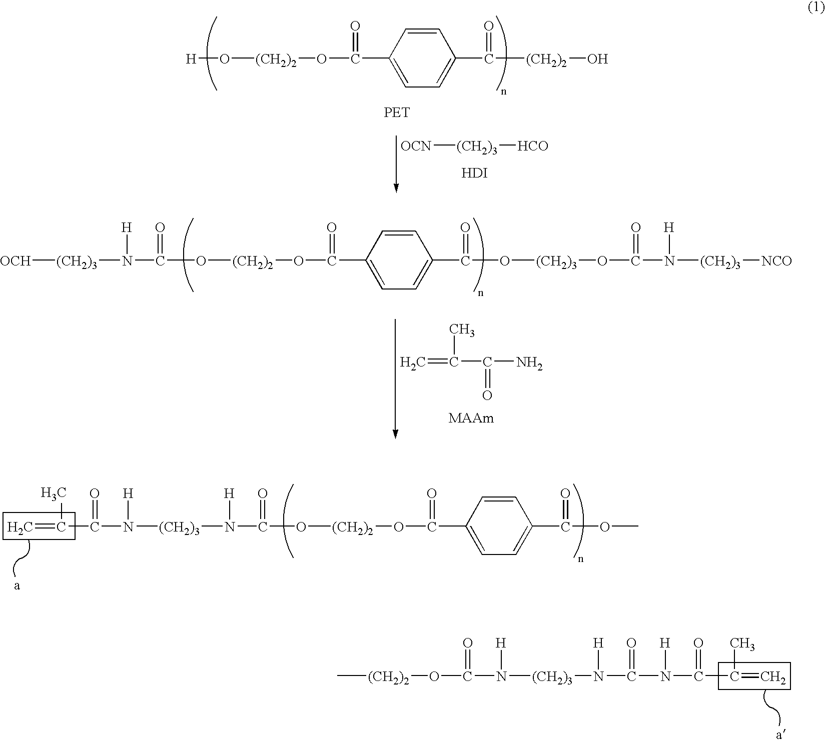

In Scheme 1, PET as the polyester is reacted with hexamethylene diisocyanate (HDI) to replace a hydroxyl group at the end portion of the PET with an isocyanate group.

Then, methacrylamide (MAAm) as a second vinyl-based monomer is added to the reaction to replace the isocyanate group of the PET with the vinyl group of the end portion of the MAAm. Thus, vinyl groups (a and a′) originating from the MAAm are present at the end portions of the PET. That is, the desired PET is obtained having the vinyl-based double bonds introduced therein.

The compound containing a diisocyanate group may be selected from the group consisting of hexamethylene diisocyanate, isophorone diisocyanate, methylenebiscyclohexyl isocyanate, toluene diisocyanate, methylenebisphenyl isocyanate, and mixtures thereof.

The monomer containing a double bond may be selected from the group consisting of an acryl amide-based monomer selected from acryl amide, methacryl amide, and hydroxymethyl acryl amide; a hydroxy acrylate-based monomer selected from hydroxymethyl acrylate, hydroxyethyl acrylate, hydroxyethyl methacrylate, hydroxymethyl methacrylate, hydroxy phenoxypropyl acrylate, hydroxy propyl acrylate, and hydroxy propyl methacrylate; and an arylamine-based monomer.

The monomer containing a double bond to be reacted with the polyester may be a silane coupling agent.

Examples of the silane coupling agent may include an amino-based silane coupling agent, an epoxy-based silane coupling agent, an acrylic-based silane coupling agent, a vinyl-based silane coupling agent and other silane coupling agents. The amino-based silane coupling agent contains an organic functional group including an amino group and a hydrolizable group such as an alkoxy group. The epoxy-based, acrylic-based, vinyl-based and other silane coupling agents contain a hydrolizable group such as an alkoxy group and an organic group such as an acrylic group, an epoxy group, a vinyl group, or a mercapto group. Thus, these silane coupling agents may aid bonding of organic materials, such as resins, etc. with inorganic materials, such as silica, glass, or metal, etc. to improve physical properties of the materials.

The silane coupling agent may contain a vinyl-based double bond. The silane coupling agent may be a vinyl-based silane coupling agent.

Scheme 2 illustrates an example of a method of introducing a double bond into a polyester by using a silane coupling agent containing a double bond. In this example, the polyester is PET.

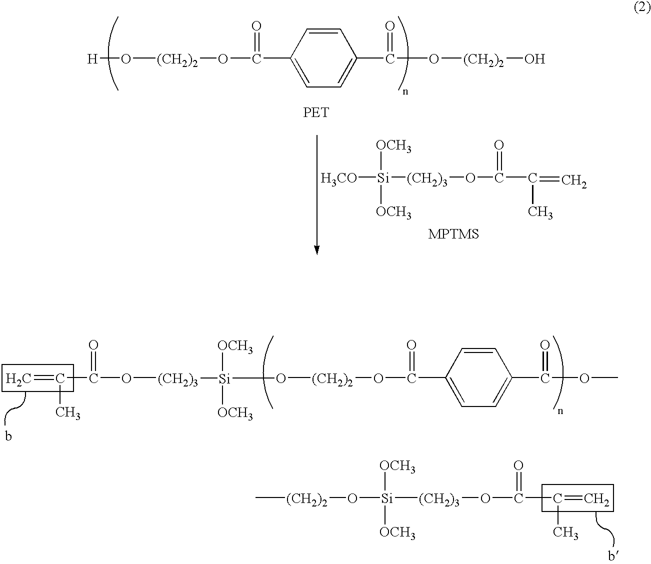

In Scheme 2, PET is reacted with methacryloxypropyltrimethoxysilane (MPTMS) to replace a hydroxyl group at the end portion of the PET with a vinyl group (b and b′).

The polyester as a polymerization monomer of a resin composition for the CPT may have a weight average molecular weight of about 1,000-100,000 and a glass transition temperature of about 40-80° C.

In an embodiment of the present invention, the polyester-macromonomer may have a weight average molecular weight of about 1,000-100,000, preferably about 5,000-30,000. If the weight average molecular weight of the polyester-macromonomer is less than 1,000, the physical properties of the resultant toner cannot be improved or the polyester-macromonomer cannot fully function as a stabilizer. If the weight average molecular weight of the polyester-macromonomer is greater than 100,000, a conversion of the reaction may decrease.

In the method of preparing a toner according to the current embodiment of the present invention, the polymerizable monomer contained in the toner composition may be selected from the group consisting of a vinyl-based monomer, a polar monomer having a carboxylic group, a monomer having an unsaturated polyester group, and a monomer having a fatty acid group.

The polymerizable monomer may be at least one selected from the group consisting of a styrene-based monomer selected from styrene, vinyltoluene, and α-methylstyrene; acrylic acid, methacrylic acid; a (meth)acrylic acid derivative selected from methyl acrylate, ethyl acrylate, propyl acrylate, butyl acrylate, 2-ethylhexyl acrylate, dimethylaminoethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, and methacrylamide; an ethylenic unsaturated monoolefin selected from ethylene, propylene, and butylene; halogenated vinyl selected from vinyl chloride, vinylidene chloride, and vinyl fluoride; vinylester selected from vinyl acetate and vinyl propionate; vinylether selected from vinylmethylether and vinylethylether; vinylketone selected from vinylmethylketone and methylisopropenylketone; a nitrogen-containing vinyl compound selected from 2-vinylpyridine, 4-vinylpyridine, and N-vinylpyrrolidone, but is not limited thereto.

The toner composition used in the current embodiment of the present invention may comprise about 0.1-80 parts by weight, preferably about 0.1-50 parts by weight, more preferably about 5-25 parts by weight of the polyester-macromonomer, based on 100 parts by weight of the polymerizable monomer.

If the concentration of the polyester-macromonomer is less than 0.1 parts by weight based on 100 parts by weight of the polymerizable monomer, dispersion stability of the toner particles may decrease and a yield of the toner particles may decrease. If the concentration of the polyester-macromonomer is greater than 80 parts by weight based on 100 parts by weight of the polymerizable monomer, the physical properties of the toner may deteriorate.

According to an embodiment of the present invention, the toner composition may comprise a pigment. A black toner may comprise carbon black or aniline black as the pigment. The toner according to an embodiment of the present invention which is non-magnetic may be useful in preparing a color toner. For the color toner, carbon black or aniline black is used to produce a black color, and yellow, magenta, and cyan pigments are used to produce chromatic colors.

Examples of the yellow pigment include a condensed nitrogen compound, an isoindolinone compound, an anthraquin compound, an azo-metal complex, and an allyl imide compound. Specifically, C.I. Pigment Yellow 12, 13, 14, 17, 62, 74, 83, 93, 94, 95, 109, 110, 111, 128, 129, 147, 168, 180, and the like, may be used.

Examples of the magenta pigment include a condensed nitrogen compound, an anthraquin compound, a quinacridone compound, a basic dye lake compound, a naphthol compound, a benzimidazole compound, a thioindigo compound, and a perylene compound. Specifically, C.I. Pigment Red 2, 3, 5, 6, 7, 23, 48:2, 48:3, 48:4, 57:1, 81:1, 122, 144, 146, 166, 169, 177, 184, 185, 202, 206, 220, 221, or 254, and the like, may be used.

Examples of the cyan pigment include a copper phthalocyanine compound and its derivatives, an anthraquin compound, and a basic dye lake compound. Specifically, C.I.

Pigment Blue 1, 7, 15, 15:1, 15:2, 15:3, 15:4, 60, 62, or 66, and the like, may be used.

The pigment may be used alone or in a mixture of two or more. The pigment is selected considering the desired hue, chroma, brightness, weather resistance, dispersion in the toner, etc.

The pigment may be used in a sufficient concentration to color a toner. For example, the concentration of the pigment in the toner composition may be about 0.1-20 parts by weight, based on 100 parts by weight of the polymerizable monomer. If the concentration of the pigment is less than 0.1 parts by weight based on 100 parts by weight of the polymerizable monomer, sufficient coloring effects cannot be attained. If the concentration of the pigment is greater than 20 parts by weight based on 100 parts by weight of the polymerizable monomer, production costs of the toner increase and sufficient frictional charge cannot be obtained.

The stabilizer may be at least one selected from the group consisting of an inorganic stabilizer, a water-soluble organic polymer stabilizer, and an anionic surfactant.

Examples of the inorganic stabilizer include an insoluble calcium salt, an insoluble magnesium salt, hydrophilic silica, hydrophobic silica, and colloidal silica.

Examples of the water-soluble organic polymer stabilizer include a non-ionic polymer stabilizer, such as polyoxyethylene alkylether, polyoxyalkylene alkylphenolether, sorbitan fatty acid ester, polyoxyalkylene fatty acid ester, glycerin fatty acid ester, polyvinyl alcohol, alkyl cellulose, or polyvinyl pyrrolidone, and an ionic polymer stabilizer, such as polyacryl amide, polyvinyl amine, polyvinyl amine N-oxide, polyvinyl ammonium salt, polydialkyldiallyl ammonium salt, polyacrylic acid, polystyrene sulfonic acid, polyacrylic acid salt, polystyrene sulfonic acid salt or polyaminoalkyl acrylic acid salt.

Examples of the anionic surfactant include fatty acid salt, alkyl sulfuric acid ester salt, alkylaryl sulfuric acid ester salt, dialkyl sulfosuccinic acid salt, and alkyl phosphoric acid salt.

The concentration of the stabilizer may be about 0.1-20 parts by weight, based on 100 parts by weight of the polymerizable monomer. If the concentration of the stabilizer is less than 0.1 parts by weight based on 100 parts by weight of the polymerizable monomer, sufficient dispersion cannot be attained. If the concentration of the stabilizer is greater than 20 parts by weight based on 100 parts by weight of the polymerizable monomer, viscosity of a polymerization composition greatly increases and it is difficult to stir the polymerization composition well. Further, the resultant particles are too small to efficiently separate them.

In the method of preparing a toner according to the current embodiment of the present invention, the dispersion medium may be an aqueous solution, an organic solvent, or a mixture thereof.

The dispersion medium and the stabilizer are mixed to obtain a stabilizer dispersion. The stabilizer dispersion may comprise about 1-10 parts by weight of the stabilizer, based on 100 parts by weight of the dispersion medium. If the concentration of the stabilizer is less than 1 part by weight based on 100 parts by weight of the dispersion medium, dispersion is rarely attained. If the concentration of the stabilizer is greater than 10 parts by weight based on 100 parts by weight of the dispersion medium, the particles are too small and a large amount of a solvent is required to rinse off the stabilizer after preparation of the particles.

Next, the stabilizer dispersion is mixed with the toner composition comprising the polyester-macromonomer, the at least one polymerizable monomer, and the pigment to form droplets. The mixing of the stabilizer dispersion with the toner composition may be performed using an ultrasonic mill, a homogenizer, or the like.

The toner composition can further include at least one component selected from the group consisting of an initiator, a chain transfer agent, a charge control agent, and a releasing agent, and thus, the droplets may also further include at least one selected from the group consisting of an initiator, a chain transfer agent, a charge control agent, and a releasing agent.

Radicals are generated from the initiator for polymerization, which may react with the polymerizable monomer. The radicals may react with reactive functional groups of the polyester-macromonomer and the polymerizable monomer to form copolymers.

Examples of the radical polymerization initiator include persulfates, such as potassium persulfate and ammonium persulfate; azo compounds, such as 4,4-azobis(4-cyanovaleric acid), dimethyl-2,2′-azobis(2-methylpropionate), 2,2-azobis(2-amidinopropan)dihydrochloride, 2,2-azobis-2-methyl-N-1,1-bis(hydroxymethyl)-2-hydroxyethylpropioamide,
2,2′-azobis(2,4-dimethylvaleronitrile), 2,2′-azobisisobutyronitrile, and 1,1′-azobis(1-cyclohexanecarbonitrile); and peroxides, such as methylethylperoxide, di-t-butylperoxide, acetylperoxide, dicumylperoxide, lauroyl peroxide, benzoylperoxide, t-butylperoxy-2-ethylhexanoate, di-isopropylperoxydicarbonate, and di-t-butylperoxyisophthalate. Further, an oxidation-reduction initiator obtained by combining the above polymerization initiator with a reducing agent may be used.

The term chain transfer agent as used herein refers to a substance which alters a chain transporter in a chain reaction. The chain transfer agent may remarkably decrease the activity of a new chain compared to that of a previous chain. By using the chain transfer agent, a degree of polymerization of the monomers may decrease or the reaction of a new chain may be initiated. The molecular weight distribution of the resultant product may be controlled using the chain transfer agent.

Examples of the chain transfer agent include, but are not limited to, a sulfur-containing compound, such as dodecanethiol, thioglycolic acid, thioacetic acid, or mercaptoethanol; a phosphorous acid compound, such as phosphorous acid or sodium phosphite; a hypophosphorous acid compound, such as hypophosphorous acid or sodium hypophosphite; and alcohol, such as methylalcohol, ethylalcohol, isopropylalcohol, or n-butylalcohol.

In an embodiment of the present invention, the releasing agent may protect a photoreceptor and prevent deterioration of developing properties, and thus may be suitably used to obtain high quality images. The releasing agent may be a high purity solid fatty acid ester substance. Specifically, examples of the releasing agent include low molecular weight polyolefin, such as low molecular weight polyethylene, low molecular weight polypropylene, and a low molecular weight polybutylene; paraffin wax; and a multifunctional ester compound, and the like. Preferably, the releasing agent may be a multifunctional ester compound formed of tri- or more functional alcohol and a carboxylic acid.

Examples of the polyhydric alcohol with tri- or more functional groups include an aliphatic alcohol, such as glycerine, pentaerythritol, or pentaglycerol; an alicyclic alcohol, such as chloroglycitol, quersitol, or inositol; an aromatic alcohol, such as tris(hydroxymethyl)benzene; a sugar, such as D-erythrose, L-arabinose, D-mannose, D-galactose, D-fructose, L-ramunose, saccharose, maltose, or lactose; and a sugar alcohol, such as erythrite, D-threit, L-arabite, or adnit.

Examples of the carboxylic acid include an aliphatic carboxylic acid, such as acetic acid, butyric acid, capronic acid, enantic acid, caprylic acid, pelargonic acid, capric acid, undecanoic acid, lauric acid, myristic acid, stearic acid, magaric acid, arachidic acid, cerotic acid, sorbic acid, linoleic acid, linolenic acid, behenic acid, or tetrolic acid; an alicyclic carboxylic acid, such as cyclohexanecarboxylic acid, hexahydroisophthalic acid, hexahydroterephthalic acid, or 3,4,5,6-tetrahydrophthalic acid; and an aromatic carboxylic acid, such as benzoic acid, cumic acid, phthalic acid, isophthalic acid, terephthalic acid, trimethic acid, trimellitic acid, or hemimellitic acid.

The charge control agent may be selected from the group consisting of a salicylic acid compound containing a metal, such as zinc or aluminum, a boron complex of bisdiphenylglycolic acid, and silicate. Specifically, the charge control agent may be dialkyl salicylic acid zinc or borobis(1,1-diphenyl-1-oxo-acetyl potassium salt).

The method of preparing a toner according to the current embodiment of the present invention will be explained below.

First, the polyester-macromonomer having double bonds introduced into ends of a molecular chain of a polyester is dissolved in a polar solvent, and then the resultant product is mixed with at least one polymerizable monomer and a pigment to obtain a uniform toner composition. Subsequently, a stabilizer dispersion is prepared by mixing a dispersion medium and a stabilizer, and the obtained stabilizer dispersion is mixed with the toner composition while being stirred, for example, using ultrasonic waves, thereby forming droplets in which the polyester-macromonomer and the polymerizable monomer are stabilized in the dispersion medium. Then, while purging with a nitrogen gas, the temperature of the resultant product is allowed to increase, and when an internal temperature of a reactor reaches a predetermined level, an initiator is added to the reactor. The internal temperature of the reactor may be 60-80° C. After the addition of the initiator, the product is warmed while being stirred at 300 rpm to perform polymerization. In an embodiment of the present invention, duration of the polymerization reaction may depend on the temperature, experimental conditions, reaction rate, conversion, and the like.

The method of preparing a toner according to the current embodiment of the present invention may further comprise rinsing off a residual suspension stabilizer from the resultant product using alcohol, or other suitable wash liquids after the suspension polymerization.

In an embodiment of the present invention, the toner composition may further comprise a wax, and thus a layer of the wax may be formed in the final toner. Further, an inhibitor may be added to the toner composition to induce a suitable polymerization reaction and to prevent formation of new latex particles.

The above layer of wax may be formed using any suitable wax that provides a desired characteristic of the final toner composition. Examples of the wax include, but are not limited to, polyethylene wax, polypropylene wax, silicone wax, paraffin wax, ester wax, carnauba wax and metallocene wax. The melting point of the wax may be about 50-150° C. The wax component physically adheres to the toner particles, but advantageously does not covalently bond to the toner particles. Thus, the toner can fuse to a final image receptor at a low fusion temperature and has excellent final image durability and resistance to abrasion.

After obtaining toner particles having desired sizes and shapes using the method of preparing a toner according to the current embodiment of the present invention, the toner particles are filtered, separated and dried. An external additive, such as silica or the like, may be added to the dried toner and the amount of electrical charge of the resultant product, etc. is controlled to obtain a final dry toner. The external additive may be large silica particles, small silica particles, or titania. The large silica particles ensure flowability and charging property of the toner particles and the small silica particles ensure a charging property of the toner particles. The titania ensures charging stability of the toner particles.

According to another embodiment of the present invention, a toner prepared by the method of producing a toner composition comprising a polyester-macromonomer having double bonds introduced into ends of the molecular chain of the polyester, at least one polymerizable monomer, and a pigment; providing a stabilizer dispersion by mixing a dispersion medium and a stabilizer, and then mixing the obtained stabilizer dispersion with the toner composition to form droplets; and heat-treating the droplets to polymerize the mixture.

The toner may have a volume average particle diameter of about 3-20 μm, and preferably about 5-8 μm.

The polyester-macromonomer may be prepared by adding a compound containing a diisocyanate group and a monomer containing a double bond sequentially to polyester.

According to another embodiment of the present invention, an image forming method comprises: attaching a toner to a surface of a photoreceptor having an electrostatic latent image formed thereon to form a visible image and transferring the visible image to a transfer material, the toner being prepared by a method of providing a toner composition comprising a polyester-macromonomer having double bonds introduced into ends of a molecular chain of a polyester, at least one polymerizable monomer, and a pigment; providing a stabilizer dispersion by mixing a dispersion medium and a stabilizer, and then mixing the obtained stabilizer dispersion with the toner composition to form droplets; and heat-treating the droplets to polymerize the mixture.

A representative electrophotographic image forming method includes a series of processes comprising charging, light-exposing, developing, transferring, fusing, cleaning and erasing, for forming images on a receptor.

In the charging process, the photoreceptor is charged with an electric charge of desired polarity, either negative or positive, by a corona or a charging roller. In the light-exposing process, an optical system, generally a laser scanner or an array of diodes form a latent image corresponding to a final visual image to be formed on an image receptor by selectively discharging the charged surface of the photoreceptor in an imagewise manner. Electromagnetic radiation, also referred to as “light” may include infrared radiation, visible rays and ultraviolet radiation.

In the developing process, in general, the toner particles with suitable polarity contact the latent image on the photoreceptor, and typically, an electrically biased developer which has a potential with the same polarity as the toner is used. The toner particles move to the photoreceptor, selectively adhere to the latent image through static electricity and form a tone image on the photoreceptor.

In the transferring process, the tone image is transferred from the photoreceptor to a desired final image receptor. Sometimes, an intermediate transferring element is used to aid the transfer of the tone image from the photoreceptor to the final image receptor.

In the fusing process, the toner image is fused to the final image receptor by melting or softening the toner particles by heating the toner image on the final image receptor. Alternatively, the toner can be fused to the final image receptor under high pressure while being heated or without heating.

In the cleaning process, the toner particles remaining on the photoreceptor are removed.

In the erasing process, a charge on the photoreceptor is exposed to light of a certain wavelength band, and the charge is substantially decreased to a uniform low value. Consequentially, a residue of the latent image is removed and the photoreceptor is prepared for the next image forming cycle.

According to another embodiment of the present invention, an image forming apparatus comprises: an organic photoreceptor; an image forming unit for forming an electrostatic latent image on a surface of the photoreceptor; a tone receiving unit for containing a toner; a toner supply unit for supplying the toner to the surface of the organic photoreceptor to develop an electrostatic latent image on the surface of the organic photoreceptor into a toner image; and a toner transfer unit for transferring the toner image from the surface of the organic photoreceptor to a transfer material, the toner being prepared by providing a toner composition comprising a polyester-macromonomer having double bonds introduced into ends of a molecular chain of a polyester, at least one polymerizable monomer, and a pigment; providing a stabilizer dispersion by mixing a dispersion medium and a stabilizer, and then mixing the obtained stabilizer dispersion with the toner composition to form droplets; and heat-treating the droplets to polymerize the mixture.

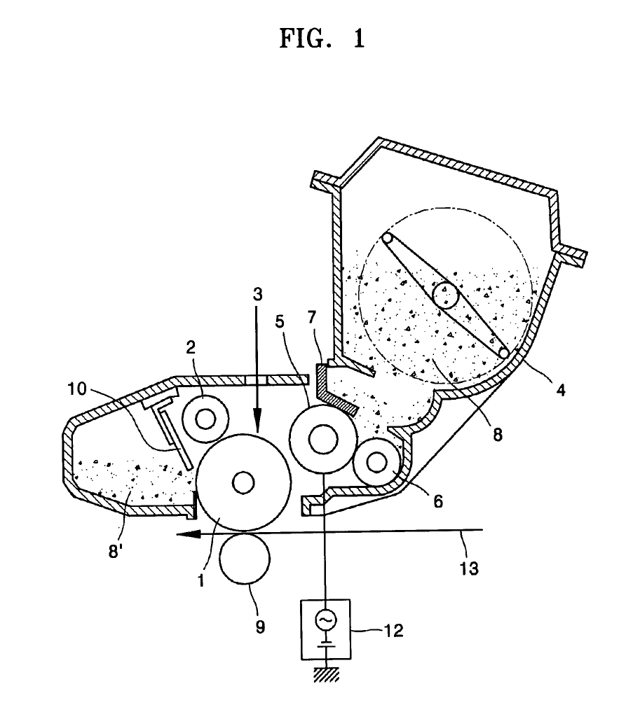

FIG. 1 is a schematic view illustrating a non-contact developing type image forming apparatus containing a toner prepared using a method according to an embodiment of the present invention. The operating principles of the non-contact developing type image forming apparatus illustrated in FIG. 1 are explained below.

Referring to FIG. 1, a non-magnetic one-component developing agent 8 of a developing unit 4 is fed to a developing roller 5 by a feeding roller 6 formed of an elastic material such as a polyurethane foam or sponge. As the developing roller 5 rotates, the non-magnetic one-component developing agent 8 on the developing roller 5 reaches a portion of the developing roller 5 where a developing agent-regulating blade 7 contacts the developing roller 5. The developing agent-regulating blade 7 may be formed of a metal or an elastic material such as rubber. When the developing agent 8 passes by the portion of the developing roller 5 where the developing agent-regulating blade 7 contacts the developing roller 5, a thin layer of the developing agent 8 with a uniform thickness is formed on the developing roller 5 and is sufficiently charged. The thin layer of the developing agent 8 is transferred to a developing region of a latent image support, i.e., a photoreceptor 1, wherein the developing agent 8 is developed on an electrostatic latent image formed on the photoreceptor 1. The electrostatic latent image is formed by scanning the photoreceptor 1 with light 3.

The developing roller 5 is disposed opposite to the photoreceptor 1 and is separated from the photoreceptor 1 by a certain interval. The developing roller 5 rotates in a counterclockwise direction and the photoreceptor 1 rotates in a clockwise direction.

The developing agent 8 transferred to the developing region of the photoreceptor 1 is developed on the electrostatic latent image of the photoreceptor 1 by an electric power generated by a potential difference between a DC-overlapped AC voltage applied to the developing roller 5 and a potential of the latent image on the photoreceptor 1 charged by a charging means 2, thereby forming a toner image.

The developing agent 8 developed on the photoreceptor 1 reaches a position of a transfer means 9 by rotation of the photoreceptor 1. When a printing paper 13 passes between the photoreceptor 1 and the transfer means 9, the developing agent 8 developed on the photoreceptor 1 is transferred to the printing paper 13 by a corona discharge or a high voltage of opposite polarity to the developing agent 8, the voltage being applied to the transfer means 9 in the form of a cylinder thereby forming an image.

As the printing paper 13 passes through a fusing apparatus (not shown) at high temperature and high pressure, the image transferred to the printing paper 13 is fused to the printing paper 13. Undeveloped developing agent 8′ remaining on the developing roller 5 is recovered by the feeding roller 6 contacting the developing roller 5 and undeveloped developing agent 8′ remaining on the photoreceptor 1 is recovered by a cleaning blade 10. The above process is repeated.

Hereinafter, the present invention will be described in more detail with reference to the following examples. However, these examples are for illustrative purposes only and are not intended to limit the scope of the invention.

### EXAMPLES

### Preparation Examples

### Preparation of Polyester-Macromonomers Having Double Bonds

### Preparation Example 1

1 g of polyethylene terephthalate (PET) as the polyester was dissolved in 50 ml of a methyl ethyl ketone (MEK) solvent, and then 0.12 g of hexamethylene diisocyanate was added to the solution. The mixture was reacted at 65° C. for 6 hours to obtain a PET having both of its ends substituted with isocyanate groups.

0.05 g of methacrylamide was added to the resultant product, and reacted at 25° C. for 24 hours to obtain a polyester-macromonomer having both of its ends substituted with vinyl-based unsaturated hydrocarbons (double bond). At this stage, a small amount of dibutyltin dilaurate (DBTDL) was added to the reaction in order to prevent a side reaction between isocyanate and OH groups.

### Preparation Example 2

1 g of PET was dissolved in 50 ml of toluene, and then 0.18 g of methacryloxypropyltrimethoxysilane (MPTMS) as a silane coupling agent was added to the solution. The mixture was reacted at 70° C. for 24 hours.

The reaction for introducing a double bond of the MPTMS into the PET may be also carried out at room temperature. Alternatively, a small amount of hydroquinone as a polymerization inhibitor may be added to the reaction at 50° C. or higher such that the double bond of the MPTMS is not lost due to polymerization at the temperature of 50° C. or higher.

### Example

### Preparation of a Toner

### Example 1

1 g of the polyester-macromonomer prepared in Preparation Example 1 was dissolved in 10 ml of a methylene chloride solvent and the resultant solution was mixed with 8 g of styrene and 2 g of butyl acrylate. Then, 0.5 g of Mogul-L as a pigment was added to the reactants to prepare a uniform toner composition. Further, 1 g of polyvinyl alcohol (PVA) was mixed with 100 g of distilled water to obtain a stabilizer dispersion. The obtained stabilizer dispersion was mixed with the toner composition while being stirred using ultrasonic waves, thereby forming droplets in which the PET-macromonomer and the styrene monomer were stabilized in the aqueous solution. While purging with a nitrogen gas, the temperature of the resultant product was increased to 70° C. 0.1 g of an initiator azobisisobutyronitrile (AIBN) was added to the reaction, which was stirred at 350 rpm for 24 hours. After completing a polymerization reaction, the resultant product was cooled to 25° C., that is, below the T_{g} of the resulting polymerized product. Then, the toner particles were separated by filtration and dried. NX-90 (Nippon Aerosil), RX-200 (Nippon Aerosil), and Titania SW-100 (Titan Kogyo), which are silica, as external additives were added to the dried toner. The ratios of the external additives NX-90, RX-200, and Titania SW-100 were respectively 3.0, 2.1, and 0.4 parts by weight, based on 100 parts by weight of the toner.

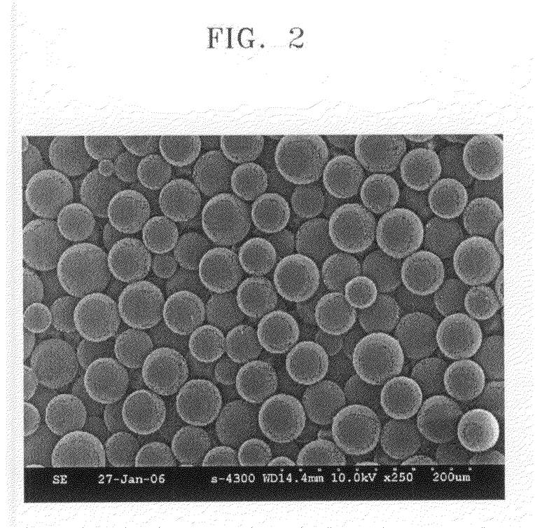

The synthesized toner was spherical and had a volume average particle diameter of about 5.5 μm. FIG. 2 is a scanning electron microscopy (SEM) photographic image illustrating a toner prepared in Example 1.

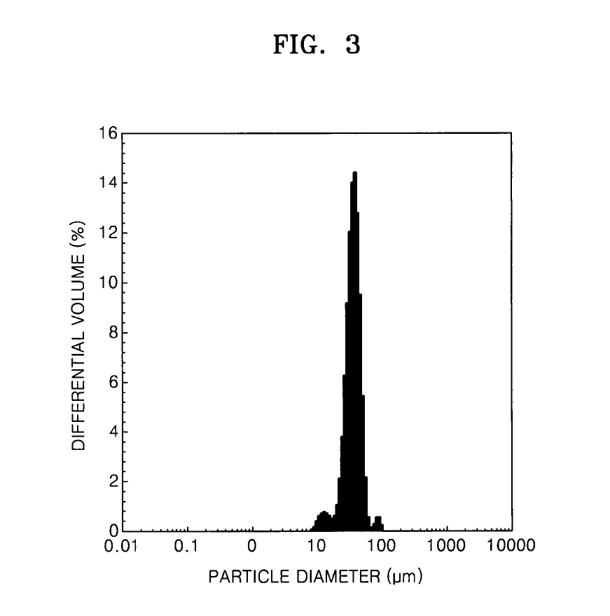

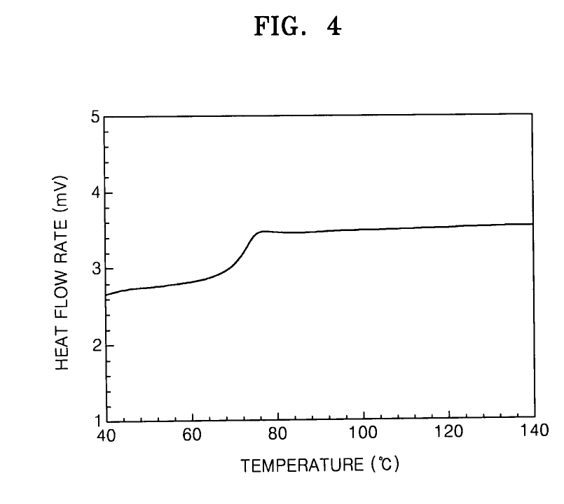

FIG. 3 is a graph illustrating particle diameter vs. differential volume the toner prepared in Example 1. FIG. 4 is a graph illustrating differential scanning calorimetry (DSC) data of the toner prepared in Example 1.

By using the method of preparing toner according to the present invention, the toner may have excellent properties of both a polyester-based monomer and a vinyl-based monomer and excellent gloss, durability, low-temperature fusing property, and stability, and types and sizes of the toner may be easily controlled.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing a toner, comprising:
providing a toner composition comprising a polyester-macromonomer having double bonds at the ends of a molecular chain of a polyester, at least one polymerizable monomer, and a pigment;
providing a stabilizer dispersion by mixing a dispersion medium and a stabilizer, and then mixing the obtained stabilizer dispersion with the toner composition to form droplets; and
heat-treating the droplets to polymerize the mixture.

2. The method of claim 1, wherein the toner composition comprises about 0.1-80 parts by weight of the polyester-macromonomer and about 0.1-20 parts by weight of the pigment, based on 100 parts by weight of the at least one polymerizable monomer.

3. The method of claim 1, wherein the polyester-macromonomer is prepared by adding and reacting a compound containing a diisocyanate group with a polyester and thereafter reacting a monomer containing a double bond with the polyester to produce the polyester-macromonomer.

4. The method of claim 3, wherein the polyester has a weight average molecular weight of about 1,000-100,000.

5. The method of claim 3, wherein the polyester has a glass transition temperature of about 40-80° C.

6. The method of claim 3, wherein the polyester is polyethylene terephthalate (PET).

7. The method of claim 3, wherein the compound containing a diisocyanate group is selected from the group consisting of hexamethylene diisocyanate, isophorone diisocyanate, methylenebiscyclohexyl isocyanate, toluene diisocyanate, methylenebisphenyl isocyanate, and mixtures thereof.

8. The method of claim 3, wherein the monomer containing a double bond is selected from the group consisting of an acryl amide-based monomer selected from acryl amide, methacryl amide, and hydroxymethyl acryl amide; a hydroxy acrylate-based monomer selected from hydroxymethyl acrylate, hydroxyethyl acrylate, hydroxyethyl methacrylate, hydroxymethyl methacrylate, hydroxy phenoxypropyl acrylate, hydroxy propyl acrylate, and hydroxy propyl methacrylate; and an arylamine-based monomer.

9. The method of claim 3, wherein the compound containing a double bond is a silane coupling agent.

10. The method of claim 1, wherein the polyester-macromonomer has a weight average molecular weight of about 1,000-100,000.

11. The method of claim 1, wherein the polymerizable monomer is selected from the group consisting of a vinyl-based monomer, a polar monomer having a carboxylic group, a monomer having an unsaturated polyester group, and a monomer having a fatty acid group.

12. The method of claim 1, wherein the polymerizable monomer is selected from the group consisting of a styrene-based monomer selected from styrene, vinyltoluene, and α-methylstyrene; acrylic acid, methacrylic acid; a (meth)acrylic acid derivative selected from methyl acrylate, ethyl acrylate, propyl acrylate, butyl acrylate, 2-ethylhexyl acrylate, dimethylaminoethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, and methacrylamide; an ethylenic unsaturated monoolefin selected from ethylene, propylene, and butylene; halogenated vinyl selected from vinyl chloride, vinylidene chloride, and vinyl fluoride; vinylester selected from vinyl acetate and vinyl propionate; vinylether selected from vinylmethylether and vinylethylether; vinylketone selected from vinylmethylketone and methylisopropenylketone; and a nitrogen-containing vinyl compound selected from 2-vinylpyridine, 4-vinylpyridine, and N-vinylpyrrolidone.

13. The method of claim 1, wherein the pigment is at least one selected from yellow, magenta, cyan, and black pigments.

14. The method of claim 1, wherein the stabilizer is selected from the group consisting of an inorganic stabilizer selected from the group consisting of an insoluble calcium salt, an insoluble magnesium salt, hydrophilic silica, hydrophobic silica, and colloidal silica; a non-ionic polymer stabilizer selected from the group consisting of polyoxyethylene alkylether, polyoxyalkylene alkylphenolether, sorbitan fatty acid ester, polyoxyalkylene fatty acid ester, glycerin fatty acid ester, polyvinyl alcohol, alkyl cellulose, and polyvinyl pyrrolidone; an ionic polymer stabilizer selected from the group consisting of polyacryl amide, polyvinyl amine, polyvinyl amine N-oxide, polyvinyl ammonium salt, polydialkyldiallyl ammonium salt, polyacrylic acid, polystyrene sulfonic acid, polyacrylic acid salt, polystyrene sulfonic acid salt and polyaminoalkyl acrylic acid salt; and an anionic surfactant selected from the group consisting of fatty acid salt, alkyl sulfuric acid ester salt, alkylaryl sulfuric acid ester salt, dialkyl sulfosuccinic acid salt, and alkyl phosphoric acid salt.

15. The method of claim 1, wherein the dispersion medium is an aqueous solution, an organic solvent, or a mixture thereof.

16. The method of claim 1, wherein the droplets further comprise at least one component selected from the group consisting of an initiator, a chain transfer agent, a charge control agent, and a releasing agent.

17. A toner prepared using the method of claim 1.

18. A toner prepared by:
providing a toner composition comprising a polyester-macromonomer having double bonds at ends of a molecular chain of a polyester, at least one polymerizable monomer, and a pigment;
providing a stabilizer dispersion by mixing a dispersion medium and a stabilizer, and then mixing the obtained stabilizer dispersion with the toner composition to form droplets; and
heat-treating the droplets to polymerize the mixture.

19. The toner of claim 18, having a volume average particle diameter of about 3-20 μm.

20. The toner of claim 18, wherein the polyester-macromonomer is prepared by adding and reacting a compound containing a diisocyanate group with a polyester and thereafter adding and reacting a monomer containing a double bond to produce the polyester macromonomer.

21. The toner of claim 18, further comprises adding at least one component selected from the group consisting of a chain transfer agent, a charge control agent, and a releasing agent.

22. An image forming method comprising:
attaching the toner of claim 18 to a surface of a photoreceptor having an electrostatic latent image formed thereon to form a visible image and transferring the visible image to a transfer material.

23. An image forming apparatus, comprising:
an organic photoreceptor;
an image forming unit for forming an electrostatic latent image on a surface of the photoreceptor;
a toner receiving unit for containing the toner of claim 18;
a toner supply unit for supplying the toner to the surface of the organic photoreceptor to develop an electrostatic latent image on the surface of the organic photoreceptor into a toner image; and
a toner transfer unit for transferring the toner image from the surface of the organic photoreceptor to a transfer material.
